(19) United States
(12) Patent Application Publication
(10) Pub. No.: US 2010/0123691 A1
(43) Pub. Date: May 20, 2010

(54) DRIVING CIRCUIT, RECORDING HEAD, IMAGE FORMING APPARATUS, AND DISPLAY DEVICE

(75) Inventor: Akira NAGUMO, Tokyo (JP)

Correspondence Address: MOTS LAW, PLLC, 1629 K STREET N.W., SUITE 602, WASHINGTON, DC, 20006-1635, US

(73) Assignee: OKI DATA CORPORATION, Tokyo (JP)

(21) Appl. No.: 12/614,582

(22) Filed: Nov. 9, 2009

(30) Foreign Application Priority Data
Nov. 19, 2008 (JP) 2008-296133

(51) Int. Cl. G09G 5/00

(52) U.S. Cl. 345/204

(57) ABSTRACT

A driving circuit includes: pixel driving circuits, each including: a driven element formed of a three-terminal light-emitting element, a control element formed of a three-terminal element and configured to control the driven element, a driving element formed of a three-terminal element and configured to drive the driven element, and a charge holding element configured to hold a charge of the driven element; a first designating circuit configured to output a first designating signal to the control element, the first designating signal designating one of the pixel driving circuits; and a second designating circuit configured to output a second designating signal to the control element, the second designating signal designating a driving state of the driven element.

### CROSS REFERENCE TO RELATED APPLICATIONS

This application claims the benefit of priority under 35 U.S.C. Section 119 of Japanese Patent Application No. 2008-296133, filed on Nov. 19, 2008 and entitled, “DRIVING CIRCUIT, RECORDING HEAD, IMAGE FORMING APPARATUS, AND DISPLAY DEVICE”, the content of which is incorporated herein by reference in its entirety.

### BACKGROUND OF THE INVENTION

1. Field of the Invention

The invention relates to a driving circuit configured to drive multiple light-emitting elements, a recording head having the driving circuit, an image forming apparatus having the recording head, and a display device having the driving circuit.

2. Description of Related Art

Some conventional image forming apparatus employ organic electroluminescence (EL) elements as light-emitting elements of a print head. In such organic EL print heads, multiple organic EL elements, which are arranged in line, emit light according to data signals sequentially at times corresponding to line scanning signals. For such an organic EP print head, as applied to conventional organic EL displays, electric current programming is used for driving the organic EL elements in pixel circuits (for example, Japanese Patent Application Publications No. Hei. 11-274569 and No. 2006-88344).

Next, a comparative example of a driving circuit is described in detail by referring to FIG. 18. FIG. 18 shows a circuit diagram of a driving circuit in a print head according to the comparative example. FIG. 18 includes print head 119, line scanning circuit 11, and input circuit 12. Input circuit 12 inputs command signals which are output by an unillustrated control circuit to command each light-emitting element to emit light and not to emit light, and to designate light-emitting intensity thereof. Each of pixel circuits 51 to 5n is surrounded by a short dashed line in FIG. 18. Each pixel circuit includes PMOS transistors TR1 and TR2, capacitor C1, and organic EL element OLED. PMOS transistors TR1 and TR2 are formed by the publicly known manufacturing process for low-temperature polysilicon thin film transistors (TFT).

PMOS transistor TR1 is a control transistor. PMOS transistor TR1 has a source connected to an output of input circuit 12 through wiring V and a drain connected to one side of capacitor C1 and a gate of PMOS transistor TR2. The other side of capacitor C1 is connected to a source of PMOS transistor TR2 and power supply VDD. PMOS transistor TR2 is a driving transistor. PMOS transistor TR2 has a drain connected to an anode terminal of organic EL element OLED. Organic EL element OLED has a cathode terminal connected to ground. The gate of PMOS transistor TR1 is connected to output P of line scanning circuit 11. Specifically, the gate of PMOS transistor TR1 in pixel circuit 51 is connected to output P1 of line scanning circuit 11 and the gate of PMOS transistor TR1 in pixel circuit 52 is connected to output P2 of line scanning circuit 11. In other words, n pixel circuits 51 to 5n are respectively connected to outputs P1 to Pn of line scanning circuit 11.

In the above-described configuration, line scanning circuit 11, such as a shift register, sequentially supplies pulsed line scanning signals (P1 to Pn), such as transfer signals, to multiple pixel circuits. When the line scanning signal is supplied to the gate of control transistor TR1 in the pixel circuit, transistor TR1 is turned on, and thereby a voltage (V) of a data signal is supplied to the gate of driving transistor TR2. When the data signal that instructs light emission (ON) is supplied to the gate of driving transistor TR2, driving transistor TR2 is turned on. Accordingly, a driving current flows into organic EL element OLED, thereby causing organic EL element OLED to emit light. On the other hand, when the data signal that instructs no light emission (OFF) is supplied to the gate of driving transistor TR2, driving transistor TR2 is turned off. Accordingly, a driving current does not flow into organic EL element OLED, thereby turning off organic EL element OLED.

As described above, pixel circuits 51 to 5n selectively cause a driving current to flow into the organic EL element (OLED), based on the line scanning signals from line scanning circuit 11. At this time, the voltage (V) of the data signal is supplied to the gate of driving transistor TR2 and the potential of the data signal is held as accumulated charges in capacitor C1. Accordingly, a driving command voltage provided to driving transistor TR2 through one line scan performed by line scanning circuit 11 is held until the next line scan to be performed by line scanning circuit 11. Thus, the pixel circuit can maintain a turn-on or turn-off state and a state of driving amount (emission intensity) of organic EL element OLED until the next scan. As a result, though having a simple configuration of two transistors TR1 and TR2 and one capacitor C1, each of pixel circuits 51 to 5n can provide a command of a driving state to organic EL element OLED.

However, the print head including the above-described organic EL elements is only applicable to a relatively low-speed printer, because of the difficulty in obtaining light-emitting power sufficiently high to expose a photoconductor, for example. The reason for the difficulty is attributed to the organic EL elements themselves. In other words, the organic EL element is inferior in light-emitting efficiency to other light-emitting elements, for example, LED elements formed of an inorganic crystal material such as AlGaAs. If a driving current is increased, the lifespan of the organic EL element is shortened due to deterioration caused by the driving current. Accordingly, it is difficult to increase the driving current, so that desired light-emitting power cannot be obtained.

Note that either of the organic EL element and the LED element is a diode. In order to turn such a diode on and off to turn the light on and off, a switch element, which can switch between supplying electric current or no electric current for the diode, is used.

Further, although having the simple configuration including two transistors TR1 and TR2 and one capacitor C1, each of the pixel circuits (51 to 5n) shown in FIG. 18 can give a command of a driving state to the light-emitting element. On the other hand, transistors which are used for the pixel circuits are generally made of a material such as low-temperature polysilicon or amorphous silicon, so that carrier mobility cannot be increased in principle. For this reason, a transistor made of such material only has small current driving capability. As described above, a print head having the foregoing configuration has problems both of light-emitting elements and driving elements, and solution of these problems is desired.

Accordingly, an object of the invention is to provide a driving circuit, a recording head, an image forming apparatus, and a display device, each of which is capable of sufficient light-emitting output while having a simple configuration.

### SUMMARY OF THE INVENTION

An aspect of the invention is a driving circuit that includes: pixel driving circuits each including a driven element formed of a three-terminal light-emitting element, a control element formed of a three-terminal element and configured to control the driven element, a driving element formed of a three-terminal element and configured to drive the driven element, and a charge holding element configured to hold a charge of the driven element; a first designating circuit configured to output a first designating signal to the control element, the first designating signal designating one of the pixel driving circuits; and a second designating circuit configured to output a second designating signal to the control element, the second designating signal designating a driving state of the driven element.

According to the aspect of the invention, by using the three-terminal light-emitting element as a driven element, the second designating signal for designating the driving state of the driven element is output from the second designating circuit to the control element, so that the light-emitting output of the driven element can be increased.

### BRIEF DESCRIPTION OF THE DRAWINGS

FIG. 1 is a block diagram showing an electrophotographic printer according to the invention;

FIG. 2 is a circuit diagram showing a print head according to a first embodiment;

FIG. 3 is a view showing the configuration of light-emitting transistor Q1 according to the first embodiment;

FIG. 4 is a perspective view of a circuit board unit of the print head;

FIG. 5 is a cross-sectional view of the circuit board unit of the print head;

FIG. 6 is a circuit diagram showing the operation of a print head according to the first embodiment;

FIG. 7 is a static characteristic graph for illustrating the operation of a TFT transistor employed for the print head according to the first embodiment;

FIG. 8 is a static characteristic graph for illustrating the operation of a light-emitting transistor employed for the print head according to the first embodiment;

FIG. 9 is a time chart showing the operation of the print head according to the first embodiment;

FIG. 10 is a circuit diagram showing a print head according to a second embodiment;

FIG. 11 is a view showing the configuration of light-emitting transistor Q2 according to the second embodiment;

FIG. 12 is a circuit diagram showing the operation of the print head of the second embodiment;

FIG. 13 is a time chart showing the operation of the print head of the second embodiment;

FIG. 14 is a configuration view showing an image forming apparatus to which the invention is applied;

FIG. 15 is a circuit diagram showing a display panel to which the invention is applied;

FIG. 16 is a mounting diagram showing a display panel;

FIG. 17 is a schematic diagram showing a mobile phone as one example of a device employing the display panel; and

FIG. 18 is a circuit diagram showing a driving circuit of a print head according to a comparative embodiment.

### DETAILED DESCRIPTION OF EMBODIMENTS

Embodiments of the invention are described below with reference to the drawings. In the following description of the drawings, identical or similar reference numerals are given to denote identical or similar portions, and the redundant description is omitted. All the drawings are schematic and ratios of dimensions and the like do not limit interpretation of the embodiments. Accordingly, specific dimensions and the like should be determined by taking the following description into consideration. Moreover, as a matter of course, dimensional relationships and ratios in some portions may be different among the drawings.

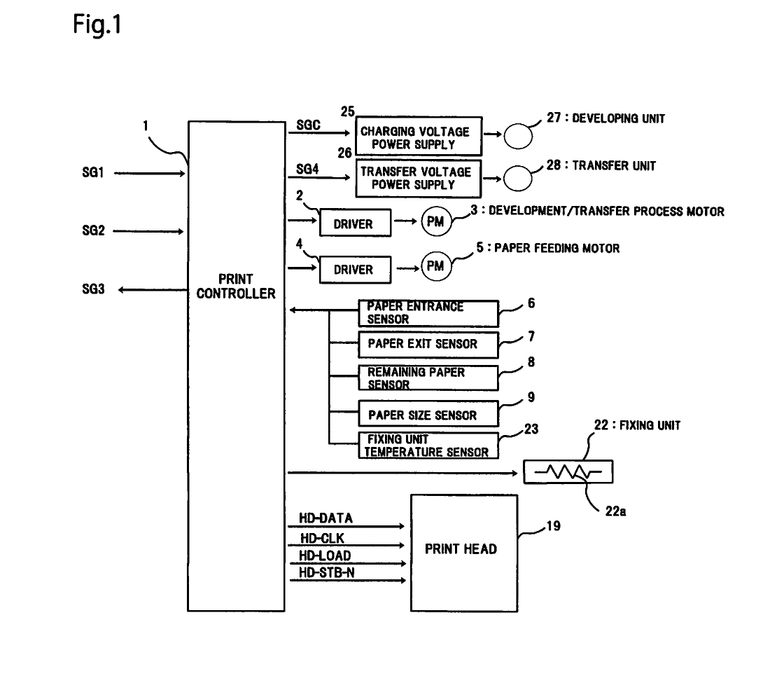

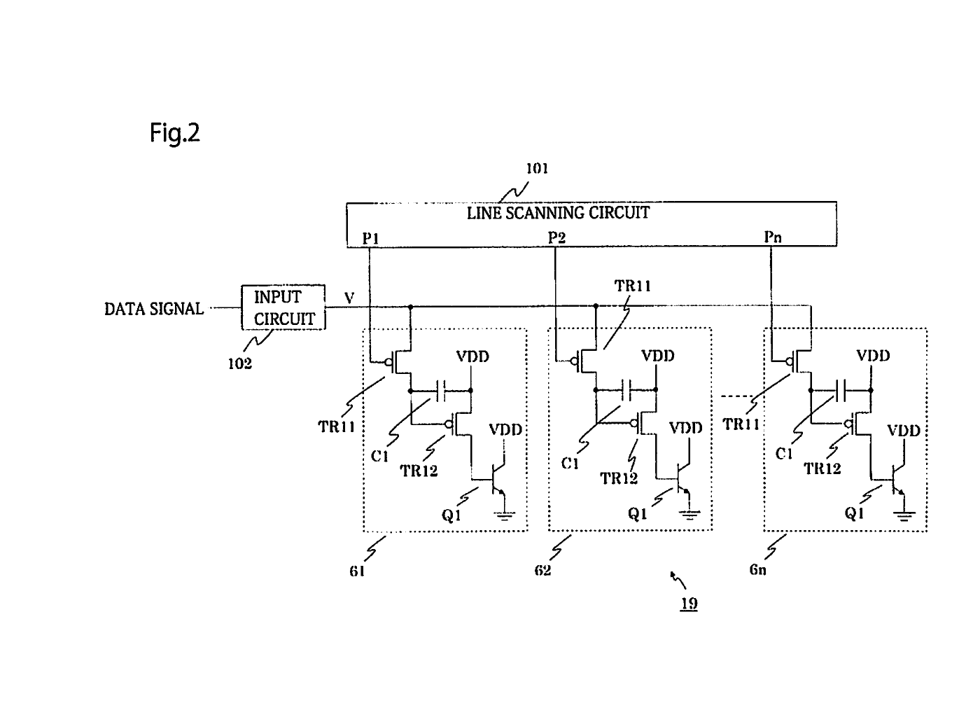

FIG. 1 is a block diagram showing an electrophotographic printer according to a first embodiment. FIG. 2 is a circuit diagram showing a print head according to the first embodiment. Each embodiment to be described below uses an electrophotographic printer as an example of an image forming apparatus. First, referring to FIG. 1, the configuration of the electrophotographic printer is described.

In FIG. 1, print controller 1 includes a microprocessor, a ROM, a RAM, an input/output port, a timer or the like, and is disposed inside a printing unit of a printer. Print controller 1 performs printing operation by sequential control of the entire printer in accordance with signals such as control signal SG1 and video signal (in which dot map data is one-dimensionally arranged) SG2, which are transmitted from an unillustrated host controller.

Upon receipt of a print instruction of control signal SG1, print controller 1 detects if fixing unit 22 having built-in heater 22a is in the range of a usable temperature, as indicated by fixing unit temperature sensor 23. If fixing unit 22 is not in the usable temperature range, print controller 1 instructs supply power to heater 22a to heat fixing unit 22 up to the usable temperature. Next, print controller 1 instructs driver 2 to rotate development and transfer process motor (PM) 3 and at the same time, turns on charging high-voltage power supply 25 based on charge signal SGC so as to charge developing unit 27.

After that, referring to remaining paper sensor 8 that detects if paper for printing is present and paper size sensor 9 that detects the size of the paper, print controller 1 starts paper feeding suitable for the paper that is detected. Note that paper feeding motor (PM) 5 can be rotated in forward and reverse directions by driver 4. Print controller 1 first drives paper feeding motor (PM) 5 to rotate in the reverse direction to feed the paper by a preset distance until paper entrance sensor 6 detects the paper. Subsequently, print controller 1 drives paper feeding motor 5 to rotate in the forward direction to convey the paper to a printing mechanism inside the printer.

At the time paper reaches a printable position, print controller 1 transmits timing signals SG3 (including main scanning and sub-scanning synchronizing signals) to the host controller and receives video signals SG2 from the host controller. Video signals SG2 which are edited page by page in the host controller, are received by print controller 1, and are transferred to print head (recording head) 19 as print data signal HD-DATA. Print head 19 has multiple light-emitting elements arranged in line, each being provided for printing one dot (pixel).

Transmission and reception of video signals SG2 are performed for each print line. The information, which is printed by print head 19, produces latent image dots having increased potential on an unillustrated negatively charged the photosensitive drum. After that, in developing unit 27, negatively charged toner for forming an image is electrically attracted to the latent image dots, which results in formation of a toner image on the photosensitive drum.

Thereafter, the toner image is sent to transfer unit 28. Transfer high-voltage power supply 26 is turned on to a positive potential in response to transfer signal SG4. As a result, transfer unit 28 transfers the toner image onto paper passing between the photosensitive drum and transfer unit 28. The paper on which the toner image is transferred is conveyed to fixing unit 22 having built-in heater 22a. The toner image is fixed to the paper by heat of fixing unit 22. The paper on which the toner image is fixed is further conveyed and discharged to the out of the printer after passing from the printing mechanism of the printer to paper exit sensor 7.

According to detection results by paper size sensor 9 and paper entrance sensor 6, print controller 1 applies a voltage from transferring high-voltage power supply 26 to transfer unit 28 only while the paper is passing through transfer unit 28. After the print is finished and the paper passes through paper exit sensor 7, print controller 1 instructs charging high-voltage power supply 25 to stop application of voltage to developing unit 27 and, at the same time, stops rotation of developing and transfer processes motor 3. This operation is repeated thereafter.

Next, print head 19 is described. FIG. 2 shows print head 19 having line scanning circuit (first designating circuit) 101 and input circuit (second designating circuit) 102 which inputs a command signal issued by an unillustrated control circuit 1 to command each light-emitting element to emit light or not to emit light, and designates light-emitting intensity thereof. Pixel circuits 61 to 61n are surrounded by short dashed lines in FIG. 2. PMOS transistors TR11 and TR12 can be formed by the publicly known low-temperature polysilicon thin film transistor (TFT) manufacturing process. Each of PMOS transistors TR11 and TR12 include three terminals: a first terminal is a source; a second terminal is a drain; and a third terminal is a gate. There are also included capacitor C1 and light-emitting transistor Q1 to be described later. Light-emitting transistor Q1 includes three terminals: a first terminal is an emitter, a second terminal is a collector, and a third terminal is a base.

PMOS transistor TR11 is a control transistor, to be described later, whose source is connected to wire V being connected to an output of input circuit 102, and drain is connected to one side of capacitor C1, and gate which is the third terminal of PMOS transistor TR12. The other side of capacitor C1 is connected to the source that is the first terminal of the PMOS transistor TR12 and power supply VDD. In addition, PMOS transistor TR12 is a driving transistor, to be described later, whose drain being the second terminal is connected to the base terminal of light-emitting transistor Q1. Collector terminal and emitter terminal of light-emitting transistor Q1 are respectively connected to power supply VDD and ground. The gate of PMOS transistor TR11 is connected to output terminal P of line scanning circuit 101. In pixel circuit 61, the gate of PMOS transistor TR11 is connected to output terminal P1 of line scanning circuit 101. In pixel circuit 62, the gate of PMOS transistor TR11 is connected to the output terminal P2 of line scanning circuit 101. Similarly, in the following description, gates of n pixel circuits are respectively connected to output terminals P1 to Pn of line scanning circuit 101.

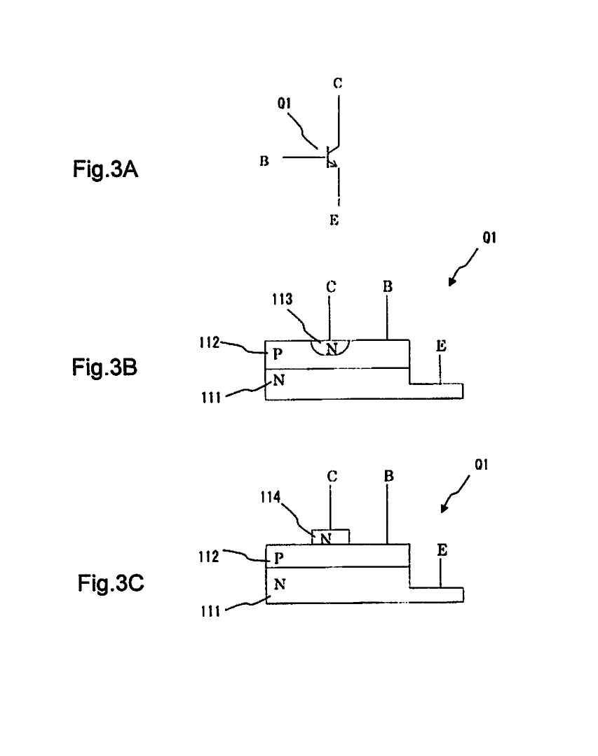

FIGS. 3A to 3C are views, each showing the configuration of light-emitting transistor Q1 shown in FIG. 2. FIG. 3A shows circuit symbols of light-emitting transistor Q1 which include three terminals, collector terminal C, base terminal B, and emitter terminal E. FIG. 3B is a view showing a cross-sectional structure of the light-emitting transistor shown in FIG. 3A. Light-emitting transistor Q1 shown in FIG. 3B employs a GaAs wafer substrate and is formed in such a manner that a predetermined crystal is epitaxially grown on an upper layer of the substrate by the publicly known metal organic-chemical vapor deposition (MO-CVD) method. Firstly, a predetermined sacrificial layer or buffer layer (unillustrated) is epitaxiallygrown. Subsequently, n-type layer 111, which is an AlGaAs substrate containing an n-type impurity, and p-type layer 112, which is an AlGaAs substrate containing a p-type impurity, are layered in that order, so that a wafer having the PN two-layer structure is formed.

Next, using the publicly known photolithography method, n-type impurity region 113 is selectively formed in a portion of p-type layer 112 which is the uppermost layer. Furthermore, devices are isolated by forming grooves using the publicly known dry etching method. In addition, in the etching process, one portion of n-type layer 111 which is the lowermost layer of the transistor is exposed, thereby forming a metal wire in that portion to form emitter electrode E. At the same time, collector electrode C and base electrode B are respectively formed in n-type impurity region 113 and p-type layer 112.

FIG. 3C shows another embodiment of light-emitting transistor Q1. In another embodiment, light-emitting transistor Q1 employs a GaAs wafer substrate and is formed in such a manner that a predetermined crystal is epitaxially grown on an upper layer of the substrate by the publicly known MO-CVD method. First, a predetermined sacrificial layer or buffer layer (unillustrated) is epitaxially grown. Subsequently, n-type layer 111, which is an AlGaAs substrate containing an n-type impurity, p-type layer 112 which is an AlGaAs substrate containing a p-type impurity, and n-type layer 114 which is an AlGaAs substrate containing an n-type impurity are layered in that order, so that a wafer having the NPN three-layer structure is formed. Furthermore, devices are isolated by forming grooves using the publically known dry etching method.

In addition, in the etching process, one portion of n-type layer 111 which is the lowermost layer of the transistor is exposed, thereby forming a metal wire in that portion to form emitter electrode E. Similarly, a portion other than a predetermined portion of n-type layer 114 which is the uppermost layer thereof is removed by etching, so that a metal wire is formed in the remaining portion to form collector electrode C. At the same time, base electrode B is also formed in p-type layer 112.

The transistor shown in FIG. 3 is formed by AlGaAs layers stacked on the GaAs wafer substrate. However, the configuration of the transistor is not limited to this, and may be formed of materials such as GaP, GaAsP, and AlGaInP or be formed in such a manner that a material such as GaN or AlGaN is deposited on a sapphire substrate. The above-described transistor is bonded with a TFT substrate, to be described later, by using the epitaxial bonding method disclosed in, for example, Japanese Patent Application Publication No. 2007-81081. In addition, an unnecessary portion of the transistor is removed by the publicly known etching method, so that terminal portions of the transistor are exposed. After that, a portion in which each terminal of the transistor is to be formed and a circuit terminal portion of the TFT substrate are bonded with each other using a thin film wire formed by the photolithography method. In this way, each composite element including the light-emitting element and the driving element can be integrally and simultaneously formed on the TFT substrate.

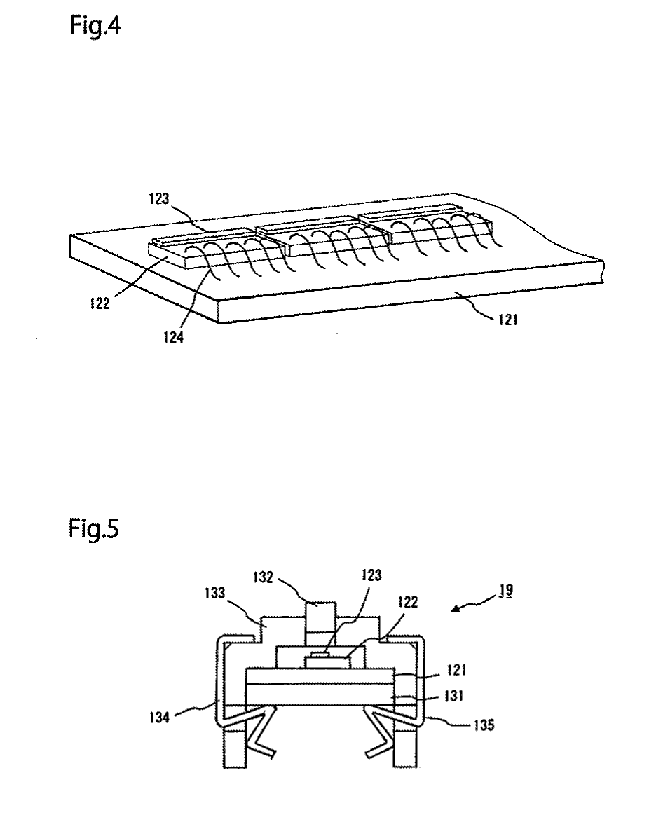

FIG. 4 is a perspective view of a circuit board unit of the print head in which the composite element including the light-emitting element and the driving element is arranged on the TFT substrate. FIG. 4 shows unit circuit board 121 on which a TFT element is formed, driving circuit 122 including the line scanning circuit and pixel circuits shown in FIG. 2, and light-emitting transistor (Q1 or the like) 123 disposed on the unit circuit board 121. FIG. 4 also shows thin film wires 124, each connecting each terminal of the driving circuit 122 with an unillustrated corresponding wiring pad on the unit circuit board 121. The driving circuit 122 and the light-emitting transistor 123 are connected using the thin film wires.

FIG. 5 is a cross-sectional view schematically showing the configuration of print head 19. As shown in FIG. 5, print head 19 includes base member 131, unit circuit board 121 fixed by base member 131, rod lens array 132 in which a number of columnar optical elements are arranged, holder 133 holding the rod lens array 132, and clamp members 134 and 135 which fix unit circuit board 121, base member 131, and holder 133. Print head 19 also includes above-described driving circuit 122 on which the driving circuits and the like are integrated and a line of light-emitting transistors (Q1) 123 which are arranged so as to be on or adjacent to driving circuit 122.

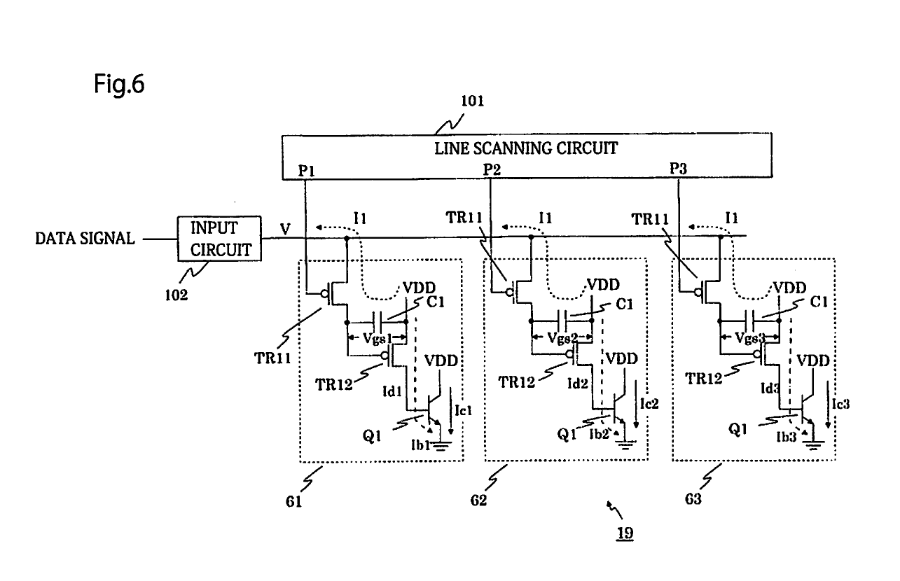

Next, the operation of print head 19 according to the first embodiment is described. FIG. 6 is a circuit diagram for illustrating the operation of the print head according to the first embodiment. For simplifying the explanation, the description is given by taking only three pixel circuits according to the first embodiment. Here, assume a case where a potential at an output unit of input circuit 102 for driving pixel circuits 61 to 63 is set to potential V, output levels at the output terminals P2 to P3 of line scanning circuit 101 are set to be high, and the terminal output P1 changes the output level from high to low. At this time, a low-level signal is applied to the gate of PMOS transistor TR11 to turn on PMOS transistor TR11. In addition, a charging current is generated in capacitor C1 as shown by short dashed arrow I1 in FIG. 6 so that the drain potential becomes substantially equal to potential V. After this transient phenomenon, the voltage across the terminals of capacitor C1 becomes Vgs1 as shown in FIG. 6.

Here, the voltage is equal to a difference between power supply voltage VDD and potential V and is expressed by a relationship of Vgs1=VDD−V. Since voltage Vgs1 is a gate-to-source voltage of PMOS transistor TR12, when the voltage Vgs1 exceeds threshold voltage Vt of PMOS transistor TR12, PMOS transistor TR12 is turned on and drain current Id1 which is determined according to the gate-to-source voltage Vgs is generated at the drain terminal of PMOS transistor TR12.

As indicated by alternate long and short dashed arrow Ib1 in FIG. 6, drain current Id1 of PMOS transistor TR12 becomes base current Ib1 of light-emitting transistor Q1. As base current Ib1 flows into light-emitting transistor Q1, light-emitting transistor Q1 is turned on and collector current Ic1 indicated by the solid arrow is generated in the collector terminal. Thus, collector current Ic1 flows into the collector of light-emitting transistor Q1 from power supply VDD, and generates a current path extending from the emitter terminal to ground. Since light-emitting transistor Q1 is formed of a compound semiconductor such as AlGaAs as described above, light emission is generated by applying a current to the PN junction surface of the compound semiconductor. Thus, a light-emitting output which is determined according to the collector current Ic1 can be obtained.

Since capacitor C1 is connected between the gate and source of above-described PMOS transistor TR12, potential Vgs1 applied across the terminals of capacitor C1 is held by accumulated charges in capacitor C1. For this reason, PMOS transistor TR12 can maintain the immediately preceding driving state in virtue of voltage Vgs1 held in the accumulated charge even after the output from output terminal P1 of line scanning circuit 101 is set to be high to turn off PMOS transistor TR11.

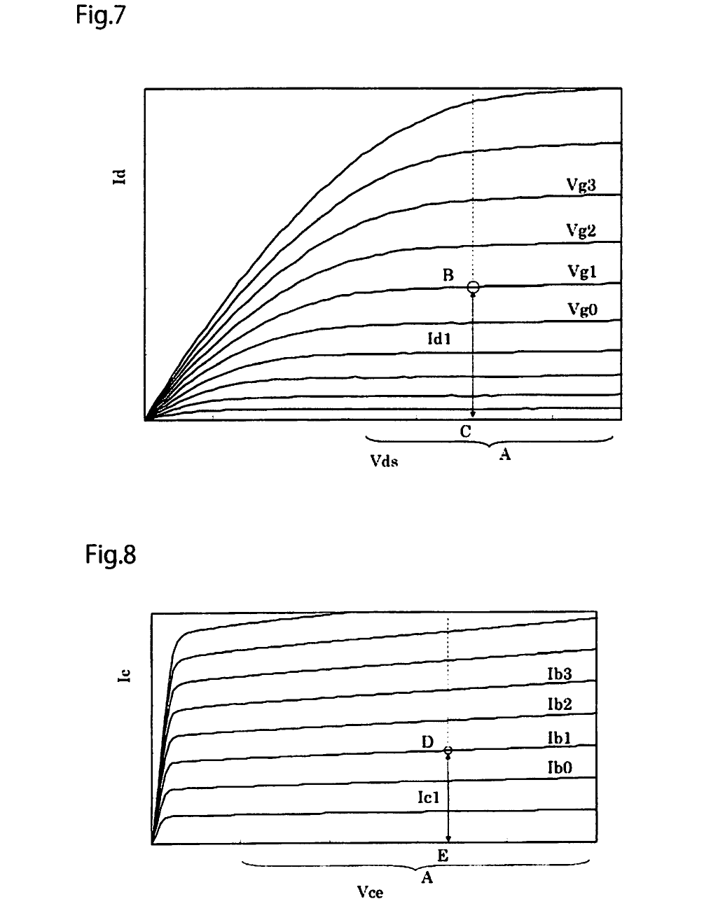

FIG. 7 is a static characteristic graph for illustrating the operation of TFT transistor TR12 which is used for print head 19 according to the first embodiment. In FIG. 7, the horizontal axis shows drain-to-source voltage Vds and the vertical axis shows drain current Id. The group of curved lines in FIG. 7 shows a case where gate-to-source voltage Vgs is constantly supplied, and four curved lines are selected from the group and are given as Vgs=Vg0, Vg1, Vg2, and Vg3 for annotation. Note that portion A in the horizontal axis shows a region where the transistor operates in the saturation region.

Here, assume that the drain-to-source voltage Vds of the TFT transistor is at point C in FIG. 7. Drain-to-source voltage Vds at that time is expressed by a relationship of Vds=VDD−Vbe, where a base-to-emitter voltage of light-emitting transistor Q1, to be described later, is set to Vbe. At this time, if the gate-to-source voltage Vgs is set to Vgs=Vg1, the point shown in FIG. 7 as B becomes an operation point and drain current Id takes a value shown by Id1 in FIG. 7. Looking at the characteristics near point B, it can be seen that PMOS transistor TR12 has a constant-current characteristic with which drain current Id is considered substantially constant even if drain-to-source voltage Vds changes somewhat. Also, if gate-to-source voltage Vgs is set to Vg0 in this state, drain current Id is decreased, whereas if gate-to-source voltage Vgs is set to Vg2, drain current Id can be increased more than point B. Thus, it can be seen that PMOS transistor TR12 functions to regulate current by using gate-to-source voltage Vgs.

FIG. 8 is a static characteristic graph for illustrating the operation of light-emitting transistor Q1 which is employed as print head 19. In FIG. 8, the horizontal axis shows collector-to-emitter voltage Vce and the vertical axis shows collector current Ic. The group of curved lines in FIG. 8 shows a case where base currents Ib are constantly supplied, and four curved lines are selected from the group in FIG. 8 and are given as Ib=Ib0, Ib1, Ib2, and Ib3 for annotation. Note that portion A in the horizontal axis shows a region where the transistor operates in the active region. Here, assume that the collector-to-emitter voltage Vce of the light-emitting transistor is at point E in FIG. 8.

As described by referring to FIG. 6, since the collector of light-emitting transistor Q1 is connected to power supply VDD, point E shown in FIG. 8 corresponds to power supply voltage VDD and a point shown by D in FIG. 8 becomes an operation point. At this time, if the base current is set to Ib=Ib1, it can be seen that collector current Ic is a value shown in FIG. 8 as Ic1 and can be considered as substantially constant even if collector-to-emitter voltage Vce changes somewhat. Also, if the base current is set to Ib0 in this state, collector current Ic is decreased, whereas if the base current is set to Ib2, collector current Ic can be increased. Thus, it can be seen that light-emitting transistor Q1 functions to regulate collector current by using the base current.

When base current Ib is applied to light-emitting transistor Q1 to generate collector current Ic, β which is defined by β=Ic/Ib is referred to as a current amplification factor and is generally β>>1. As described by referring to FIG. 8, β has an advantage that a slight change of the base current can greatly change the collector current.

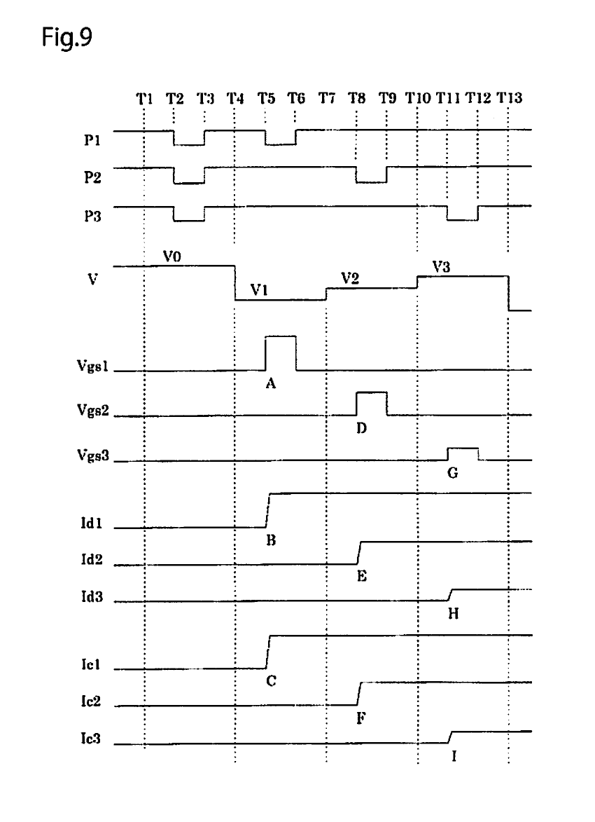

FIG. 9 is a time chart for illustrating the operation of the circuit in FIG. 6 and shows the operation in a case where three adjacent pixel circuits 61 to 63 are driven in turn to emit light in response to a command from line scanning circuit 101. Signal waveforms P1 to P3 in FIG. 9 respectively show waveforms output from output terminals P1 to P3 of line scanning circuit 101. Waveform V is an output voltage from input circuit 102. Waveforms Vgs1 to Vgs3 respectively show gate-to-source voltages of PMOS transistors TR12 in pixel circuits 61 to 63. Waveforms Id1 to Id3 respectively show drain current waveforms of PMOS transistors TR12 in pixel circuits 61 to 63, and are equal to base currents Ib1 to Ib3 of light-emitting transistors Q1 as is clear from FIG. 6. Also, waveforms Ic1 to Ic3 respectively show collector current waveforms of light-emitting transistors Q1 in pixel circuits 61 to 63.

The operation is described hereinbelow in turn for each time point described in the time chart.

Time point T1: at time point T1 when light-emission control for a line is started, outputs from output terminals P1 to P3 of line scanning circuit 101 are set to be high. At this time, a set potential, which is an output from input circuit 102, of driving wire V is set to V0. Time point T2: outputs from output terminals P1 to P3 of line scanning circuit 101 are set to be low. As a result, multiple PMOS transistors TR11 in pixel circuits 61 to 63 are turned on to transmit voltage V0 to respective capacitors C1. As described above, voltage Vgs across the terminals of capacitor C1 becomes Vgs=VDD−V. Accordingly, set potential V0 is set so that voltage Vgs becomes smaller than the threshold voltage Vt of PMOS transistor TR12. As a result, gate-to-source voltages Vgs1 to Vgs3 of PMOS transistor TR12 are made equal to or smaller than threshold voltage Vt, so that PMOS transistors TR12 in pixel circuits 61 to 63 can be turned off. Accordingly, all light-emitting transistors Q1 in pixel circuits 61 to 63 are turned off.

Time point 3: outputs from output terminals P1 to P3 of line scanning circuit 101 are set to be high. The set state of on or off depends on the state of accumulated charges in capacitor C1. Accordingly, even after outputs from output terminals P1 to P3 of the line scanning circuit are returned to be high at time point T3, the set state is maintained. Consequently, all light-emitting transistors Q1 are kept turned off.

Time point T4: a set potential, which is an output from input circuit 102, of driving wire V is set to V1. Time point T5: an output from output terminal P1 of line scanning circuit 101 is set to be low. Accordingly, PMOS transistor TR11 in pixel circuit 61 is turned on.

As described above, gate-to-source voltage Vgs1 of PMOS transistor TR12 in pixel circuit 61, which is currently set as Vgs1=VDD−V1, raises as shown by portion A in FIG. 9 corresponding to the decrease of set potential V from V0, which is the initial state, to V1. Since voltage Vgs1 exceeds threshold voltage Vt of PMOS transistor TR12, drain terminal of PMOS transistor TR12 generates current which is shown as waveform Id1 (as shown by portion B in FIG. 9). Current Id1 is equal to base current Ib1 which flows through transistor Q1. With the flow of base current Ib1, collector current Ic1 which is amplified by current amplification factor β flows through light-emitting transistor Q1 (as shown by portion C in FIG. 9).

Time point T6: an output from output terminal P1 of line scanning circuit 101 is set to be high. Accordingly, PMOS transistor TR11 in pixel circuit 61 is turned off, but voltage Vgs1 is still kept in capacitor C1. Thus, the driving states of PMOS transistor TR12 and light-emitting transistor Q1 in pixel circuit 61 can be maintained as they are.

Time point T7: a set potential, which is an output from input circuit 102, of driving wire V is set to V2. Time point T8: an output from output terminal P2 of line scanning circuit 101 is set to be low. Accordingly, PMOS transistor TR11 in pixel circuit 62 is turned on. As described above, gate-to-source voltage Vgs2 of PMOS transistor TR12 in pixel circuit 62, which is currently set as Vgs2=VDD−2, raises as shown by portion D in FIG. 9 corresponding to the decrease of set potential V from V0, which is the initial state, to V2. Since voltage Vgs2 exceeds threshold voltage Vt of PMOS transistor TR12, drain terminal of PMOS transistor TR12 generates current which is shown as waveform Id2 (as shown by portion E in FIG. 9). Current Id2 is equal to base current Ib2 which flows through transistor Q1. With the flow of base current Ib2, collector current Ic2 which is amplified by current amplification factor β flows through light-emitting transistor Q1 (as shown by portion F in FIG. 9).

Time point T9: an output from output terminal P2 of line scanning circuit 101 is set to be high. Accordingly, PMOS transistor TR11 in pixel circuit 62 is turned off, but voltage Vgs2 is still kept in capacitor C1. Thus, the driving states of PMOS transistor TR12 and light-emitting transistor Q1 in pixel circuit 62 can be maintained as they are.

Time point T10: a set potential, which is an output from input circuit 102, of driving wire V is set to V3. Time point T11: an output from output terminal P3 of line scanning circuit 101 is set to be low. Accordingly, PMOS transistor TR11 in pixel circuit 63 is turned on.

As described above, gate-to-source voltage Vgs3 of PMOS transistor TR12 in pixel circuit 63, which is currently set as Vgs3=VDD−3, raises as shown by portion G in FIG. 9 corresponding to the decrease of set potential V from V0, which is the initial state, to V3. Since voltage Vgs3 exceeds threshold voltage Vt of PMOS transistor TR12, drain terminal of PMOS transistor TR12 generates current which is shown as waveform Id3 (as shown by portion H in FIG. 9). Current Id3 is equal to base current Ib3 which flows through transistor Q1. With the flow of base current Ib3, collector current Ic3 which is amplified by current amplification factor β flows through light-emitting transistor Q1 (as shown by portion I in FIG. 9). Time point T12: an output from output terminal P3 of line scanning circuit 101 is set to be high. Accordingly, PMOS transistor TR11 in pixel circuit 63 is turned off, but voltage Vgs3 is still kept in capacitor C1. Thus, the driving states of PMOS transistor TR12 and light-emitting transistor Q1 in pixel circuit 63 can be maintained as they are.

As described above, the set potential, which is an output from input circuit 102, of driving wiring V is changed from V0 to V1, V2, and V3. Along with these changes, multiple output signals from line scanning circuit 101 are selectively set to turn-on state, so as to designate pixel circuits 61 to 63 to generate driving current. In this way, the output signals are capable of instructing light-emitting transistor Q1 to start emitting light. Moreover, the set potential of driving wire V is set to be a command signal of the driving state to pixel circuits 61 to 63. In the description referring to FIG. 9, the set potentials, which are outputs from input circuit 102, of driving wiring V are expressed as different values of V0, V1, V2, and V3. However, if the driving states of pixel circuits 61 to 63 do not need to be changed, the same set potentials may be set for all the cases. Also, if there is no need to drive a target pixel circuit, the set potential, which is an output from input circuit 102, of driving wire V at a corresponding time point may be set to be equal to, for example, V0 which is the initial voltage, so that the corresponding pixel can be turned off. Moreover, a pixel which is instructed to start emitting light by the line driving may be turned off with an instruction of turning off by a similar process in the next line.

As described above, line scanning circuit 101 is used to scan pixels sequentially, so that pixel circuits 61 to 63 which are arranged in line can be turn on or off as needed. Moreover, each pixel can be driven to be any of driving states. Thus, even if light-emitting efficiency varies slightly due to variations or the like among light-emitting elements caused during the light-emitting element manufacturing processes, the effects of the variations can be solved by changing a command voltage of the driving state so as to correct the variations.

An organic EL diode which is used in a print head having a conventional configuration has following problems. Specifically, one of the problems is that increasing driving current is difficult so that desired light-emitting power can not be obtained because a lifespan of the organic EL diode becomes shorter due to electrical deterioration. The other problem is that current driving capability of a transistor is small and light-emitting luminous energy of a driven element which is driven by the transistor falls short because the transistor used for the driving the element is manufactured by the publicly known TFT technique using a material such as low-temperature polysilicon or amorphous silicon in which carrier mobility cannot be increased.

In the first embodiment, as is clear from FIG. 6 showing the configuration of the first embodiment, light-emitting transistor Q1 made of a crystal material such as AlGaAs substrate is used as light-emitting element in place of an organic EL diode. Thus, there is no problem of aged deterioration so that the driving current can be increased, thereby obtaining larger light-emitting output. In addition, the current amplification factor of light-emitting transistor Q1 is large, and a small base current has a large current driving capability. As a result, even if a TFT element whose current driving capability is inferior as a driving circuit for controlling light-emitting transistor Q1 is used, the TFT element can sufficiently perform the control. Accordingly, the first embodiment can solve a technical problem included in the conventional configuration.

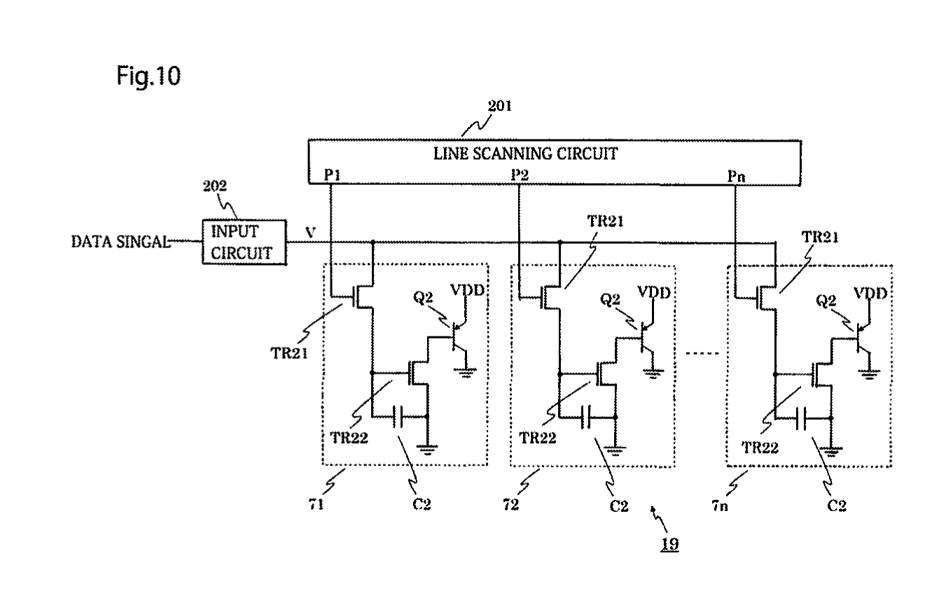

Next, a second embodiment is described. FIG. 10 shows the configuration of print head 19 according to a second embodiment. FIG. 10 shows print head 19 having line scanning circuit 201 and input circuit 202 which inputs a command signal issued by an unillustrated control circuit to command each light-emitting element to emit light or not to emit light, or to designate light-emitting intensity thereof. Pixel circuits 71 to 71n are surrounded by short dashed lines in FIG. 10. NMOS transistors TR21 and TR22 can be formed by the publicly known low-temperature polysilicon thin film transistor (TFT) manufacturing process. Each of NMOS transistors TR21 and TR22 is a three-terminal element including three terminals: a first terminal is a source, a second terminal is a drain, and a third terminal is a gate. There are also included capacitor C2 and light-emitting transistor Q2 to be described later. Light-emitting transistor Q2 includes three terminals: a first terminal is an emitter, a second terminal is a collector, and a third terminal is a base.

NMOS transistor TR21 is a control transistor, to be described later, whose source is connected to wire V being connected to an output of input circuit 202 and drain is connected to one side of capacitor C2 and the gate of NMOS transistor TR22. The other side of capacitor C2 is connected to the source of NMOS transistor TR22 and ground. Also, NMOS transistor TR22 is a driving transistor to be described later whose drain is connected to the base terminal of light-emitting transistor Q2. The emitter terminal of light-emitting transistor Q2 is connected to power supply VDD and the collector terminal thereof is connected to ground. The gate of NMOS transistor TR21 is connected to output terminal P of line scanning circuit 201. In pixel circuits 71, the gate of NMOS transistor TR21 is connected to output terminal P1 of line scanning circuit 201. In pixel circuit 72, the gate of NMOS transistor TR21 is connected to output terminal P2 of line scanning circuit 201. Similarly, in the following description, gates of n pixel circuits are respectively connected to output terminals P1 to Pn of line scanning circuit 201.

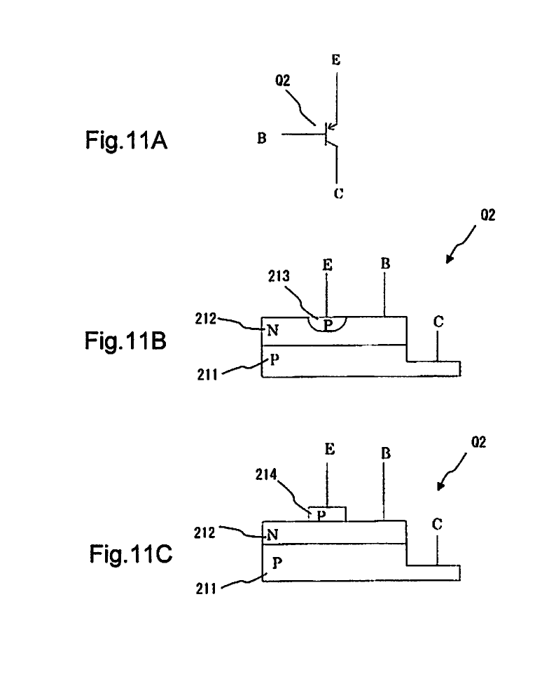

FIGS. 11A to 11C are views, each showing the configuration of light-emitting transistor Q2 shown in FIG. 10. FIG. 11A shows circuit symbols of light-emitting transistor Q2 which includes three terminals of collector terminal C, base terminal B, and emitter terminal E. FIG. 11B is a view showing a cross-sectional structure of light-emitting transistor Q2 shown in FIG. 11A. Light-emitting transistor Q2 of the second embodiment shown in FIG. 11B employs a GaAs wafer substrate and is formed in such a manner that a predetermined crystal is epitaxially grown on an upper layer of the substrate by the publicly known MO-CVD method.

First, a predetermined sacrificial layer or buffer layer (unillustrated) is epitaxially grown. Subsequently, p-type layer 211, which is an AlGaAs substrate containing a p-type impurity, and n-type layer 212, which is an AlGaAs substrate containing an n-type impurity, are layered in that order, so that a wafer having the NP two-layer structure is formed. Next, using the publicly known photolithography method, p-type impurity region 213 is selectively formed in a portion of n-type layer 212 in the uppermost layer. Furthermore, devices are isolated by forming grooves using the publically known dry etching method. In addition, in the etching process, one portion of p-type layer 211 which is the lowermost layer of the transistor is exposed, thereby forming a metal wire in the portion to form collector electrode C. At the same time, emitter electrode E and base electrode B are respectively formed in p-type region 213 and n-type layer 212.

FIG. 11C shows another embodiment of light-emitting transistor Q2. In another embodiment shown in FIG. 11C, light-emitting transistor Q2 employs a GaAs wafer substrate and is formed in such a manner that a predetermined crystal is epitaxially grown on an upper layer of the substrate by the publicly known MO-CVD method. First, a predetermined sacrificial layer or buffer layer (unillustrated) is epitaxially grown. Subsequently, p-type layer 211 which is an AlGaAs substrate containing a p-type impurity, n-type layer 212 which is an AlGaAs substrate containing an n-type impurity, and p-type layer 214 which is an AlGaAs substrate containing a p-type impurity are layered in this order, so that a wafer having the PNP three-layer structure is formed.

Furthermore, devices are isolated by forming grooves using the publicly known dry etching method. In addition, in the etching process, one portion of p-type layer 211 which is the lowermost layer of the transistor is exposed, thereby forming a metal wire in the portion to form collector electrode C. Similarly, a portion other than a predetermined portion of p-type region 214 which is the uppermost layer thereof is removed by etching, so that a metal wire is formed in the remaining portion to form emitter electrode E. At the same time, base electrode B is also formed in n-type layer 212.

The transistor shown in FIG. 11 is formed by AlGaAs layers stacked on the GaAs wafer substrate. However, the configuration of the transistor is not limited to this, and may be formed of materials such as GaP, GaAsP, and AlGaInP or be formed in such a manner that a material such as GaN or AlGaN is deposited on a sapphire substrate. The above-described transistor element is bonded with the TFT substrate by using the epitaxial bonding method disclosed in, for example, Japanese Patent Application Publication No. 2007-81081. In addition, an unnecessary portion of the transistor element is removed by the publicly known etching method, so that terminal portions of the transistor element are exposed. After that, a portion in which each terminal of the transistor is to be formed and a circuit terminal portion of the TFT substrate are bonded with each other using a thin film wire formed by the photolithography method. In this way, each composite element formed of the light-emitting element and the driving element can be integrally and simultaneously formed on the TFT substrate.

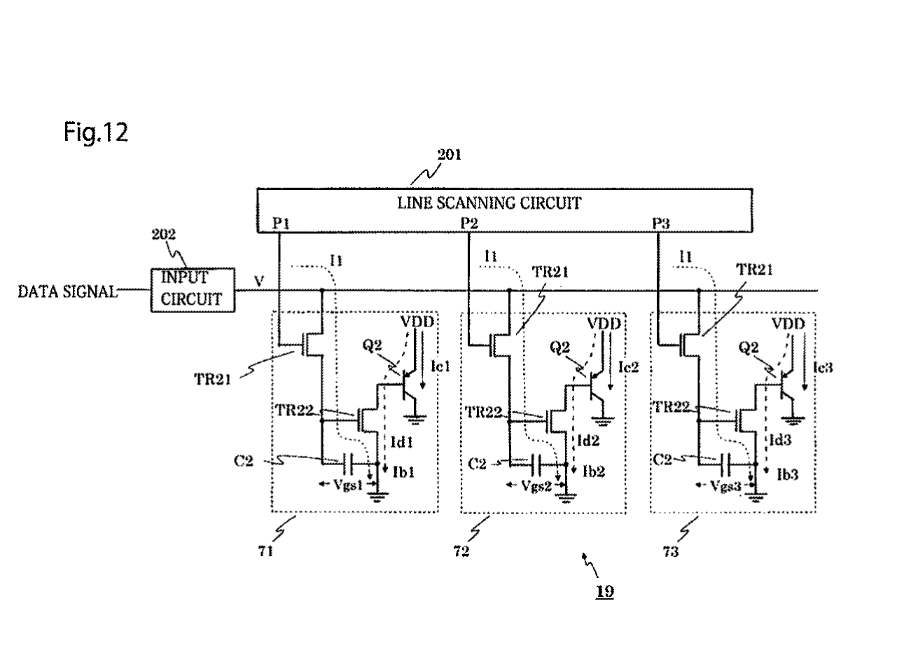

FIG. 12 is a circuit diagram for illustrating the operation of the print head according to the second embodiment shown in FIG. 10. For simplifying the explanation, the description is given by taking three pixel circuits 71 to 73 out of the pixel circuits shown in FIG. 10. Here, assume a case where a potential at an output unit of input circuit 202 for driving pixel circuits 71 to 73 is set to potential V, output levels at the output terminals P2 to P3 of line scanning circuit 201 are set to be low, and the terminal output P1 changes the output level from low to high.

At this time, a high-level signal is applied to the gate of NMOS transistor TR21 to turn on NMOS transistor TR21. In addition, a charging current is generated in capacitor C2 as shown by short dashed arrow I1 in FIG. 12 so that the drain potential becomes substantially equal to potential V. After this transient phenomenon, the voltage across the terminals of capacitor C2 becomes Vgs1 as shown in FIG. 12. Here, the voltage is equal to potential V and is expressed by a relationship of Vgs1=V. Since voltage Vgs1 is a gate-to-source voltage of NMOS transistor TR22, when the voltage Vgs1 exceeds threshold voltage Vt of NMOS transistor TR22, NMOS transistor TR22 is turned on and drain current Id which is determined according to the gate-to-source voltage Vgs is generated at the drain terminal of NMOS transistor TR22.

As indicated by alternate long and short dashed arrow Ib1 in FIG. 12, drain current Id becomes base current Ib1 of light-emitting transistor Q2. As base current Ib1 flows into light-emitting transistor Q2, light-emitting transistor Q2 is turned on and collector current Ic1 indicated by the solid arrow is generated in the collector terminal. Thus, collector current Ic1 flows into the emitter of light-emitting transistor Q2 from power supply VDD, and generates a current path extending from the collector terminal to ground. Since light-emitting transistor Q2 is formed of a compound semiconductor such as AlGaAs as described above, light emission is generated by applying a current to the PN junction surface of the compound semiconductor. Thus, a light-emitting output which is determined according to collector current Ic1 can be obtained.

Since capacitor C2 is connected between the gate and source of above-described NMOS transistor TR22, potential Vgs1 given across the terminals of capacitor C2 is held by accumulated charges in capacitor C2. For this reason, NMOS transistor TR22 can maintain the immediately preceding driving state in virtue of voltage Vgs1 held in the accumulated charge even after the output from output terminal P1 of line scanning circuit 201 is set to be low to turn off NMOS transistor TR21.

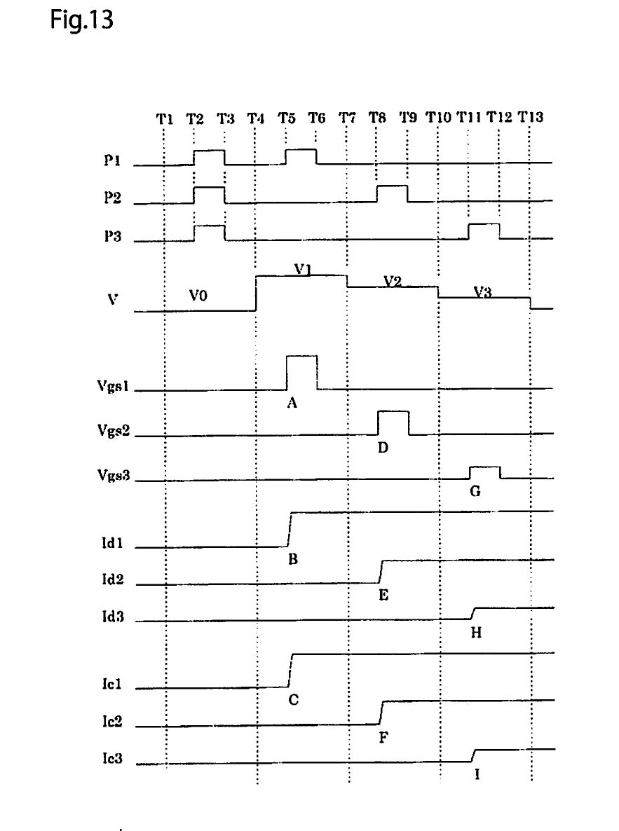

FIG. 13 is a time chart for illustrating the operation of the circuit in FIG. 12 and shows the operation in a case where three adjacent pixel circuits 71 to 73 are driven in turn to emit light in response to a command from line scanning circuit 201. Signal waveforms P1 to P3 in FIG. 13 respectively show waveforms of outputs from output terminals P1 to P3 of line scanning circuit 201. Waveform V is a waveform of an output voltage from input circuit 202. Waveforms Vgs1 to Vgs3 respectively show gate-to-source voltages of NMOS transistors TR22 in pixel circuits 71 to 73. Waveforms Id1 to Id3 respectively show drain current waveforms of NMOS transistors TR22 in pixel circuits 71 to 73, and are equal to base currents Ib1 to Ib3 of light-emitting transistors Q2 as is clear from FIG. 12. Also, waveforms Ic1 to Ic3 respectively show collector current waveforms of light-emitting transistors Q2 in pixel circuits 71 to 73.

The operation is described hereinbelow in turn for each time point described in the time chart. Time point T1: at time point T1 when light-emission control for a line is started, outputs from output terminals P1 to P3 of line scanning circuit 201 are set to be low. At this time, a set potential, which is an output from input circuit 202, of driving wire V is set to V0. Time point T2: outputs from output terminals P1 to P3 of line scanning circuit 201 are set to be high. As a result, multiple NMOS transistors TR21 in pixel circuits 71 to 73 are turned on to transmit voltage V0 to respective capacitors C2.

As described above, voltage Vgs across the terminals of capacitor C2 becomes Vgs=V. Accordingly, set potential V0 is set so that voltage Vgs becomes smaller than the threshold voltage Vt of NMOS transistor TR22. As a result, gate-to-source voltages Vgs1 to Vgs3 of NMOS transistors TR22 in pixel circuits 71 to 73 are made equal to or smaller than threshold voltage Vt, so that NMOS transistors TR22 in pixel circuits 71 to 73 can be turned off. Accordingly, all light-emitting transistors Q2 in pixel circuits 71 to 73 are turned off.

Time point T3: outputs from output terminals P1 to P3 of line scanning circuit 201 are set to be low. The set state of on or off depends on the state of accumulated charges in capacitor C2. Accordingly, even after the outputs from output terminals P1 to P3 of line scanning circuit 201 are returned to be low at time point T3, the set state is maintained. Consequently, all light-emitting transistors Q2 are kept turned off. Time point T4: a set potential, which is an output from input circuit 202, of driving wire V is set to V1. Time point T5: an output from output terminal P1 of line scanning circuit 201 is set to be high. Accordingly, NMOS transistor TR21 in pixel circuit 71 is turned on.

As described above, gate-to-source voltage Vgs1 of NMOS transistor TR22 in pixel circuit 71, which is currently set as Vgs1=VDD−V1, raises as shown by portion A in FIG. 13 corresponding to the increase of set potential V from V0, which is the initial state, to V1. Since voltage Vgs1 exceeds threshold voltage Vt of NMOS transistor TR22, drain terminal of NMOS transistor TR22 generates current which is shown as waveform Id1 (as shown by portion B in FIG. 13). Current Id1 is equal to base current Ib1 which flows through transistor Q2. With the flow of base current Ib1, collector current Ic1 which is amplified by current amplification factor β flows through light-emitting transistor Q2 (as shown by portion C in FIG. 13).

Time point T6: an output from output terminal P1 of line scanning circuit 201 is set to be low. Accordingly, NMOS transistor TR21 in pixel circuit 71 is turned off, but voltage Vgs1 is still kept in capacitor C2. Thus, the driving states of NMOS transistor TR22 and light-emitting transistor Q2 in pixel circuit 71 can be maintained as they are. Time point T7: a set potential, which is an output from input circuit 202, of driving wire V is set to V2. Time point T8: an output from output terminal P2 of line scanning circuit 201 is set to be high. Accordingly, NMOS transistor TR21 in pixel circuit 72 is turned on.

As described above, gate-to-source voltage Vgs2 of NMOS transistor TR22 in pixel circuit 72, which is currently set as Vgs2=V2, raises as shown by portion D in FIG. 13 corresponding to the increase of set potential V from V0, which is the initial state, to V2. Since voltage Vgs2 exceeds threshold voltage Vt of NMOS transistor TR22, drain terminal of NMOS transistor TR22 generates current which is shown as waveform Id2 (as shown by portion E in FIG. 13). Current Id2 is equal to base current Ib2 which flows through light-emitting transistor Q2. With the flow of base current Ib2, collector current Ic2 which is amplified by current amplification factor β flows through light-emitting transistor Q2 (as shown by portion F in FIG. 13).

Time point T9: an output from output terminal P2 of line scanning circuit 201 is set to be low. Accordingly, NMOS transistor TR21 in pixel circuit 72 is turned off, but voltage Vgs2 is still kept in capacitor C2. Thus, the driving states of NMOS transistor TR22 and light-emitting transistor Q2 in pixel circuit 72 can be maintained as they are. Time point T10: a set potential, which is an output from input circuit 102, of drive wiring V is set to V3. Time point T11: an output from output terminal P3 of line scanning circuit 201 is set to be high. Accordingly, NMOS transistor TR21 in pixel circuit 73 is turned on.

As described above, gate-to-source voltage Vgs3 of NMOS transistor TR22 in pixel circuit 73, which is currently set as Vgs3=V3, raises as shown by portion G in FIG. 13 corresponding to the increase of set potential V from V0, which is the initial state, to V3. Since voltage Vgs3 exceeds threshold voltage Vt of NMOS transistor TR22, drain terminal of NMOS transistor TR22 generates current which is shown as waveform Id3 (as shown by portion H in FIG. 13). Current Id3 is equal to base current Ib3 which flows through transistor Q2. With the flow of base current Ib3, collector current Ic3 which is amplified by current amplification factor β flows through light-emitting transistor Q2 (as shown by portion I in FIG. 13). Time point T12: an output from output terminal P3 of line scanning circuit 201 is set to be low. Accordingly, NMOS transistor TR21 in pixel circuit 73 is turned off, but voltage Vgs3 is still kept in capacitor C2. Thus, the driving states of NMOS transistor TR22 and light-emitting transistor Q2 in pixel circuit 73 can be maintained as they are.

As described above, the set potential, which is an output from input circuit 202, of driving wiring V is changed from V0 to V1, V2, and V3. Along with these changes, output signals from line scanning circuit 201 are selectively set to turn-on state, so as to designate pixel circuits 71 to 73 to generate driving current. In this way, the output signals are capable of instructing light-emitting transistor Q2 to start emitting light. Moreover, the set potential of driving wiring V is a command signal of the driving state to pixel circuits 71 to 73.

In the description referring to FIG. 13, the set potentials, which are outputs from input circuit 202, of driving wire V are expressed as different values of V0, V1, V2, and V3. However, if the driving states of pixel circuits 71 to 73 do not need to be changed, the same set potentials may be set for all the cases. Also, if there is no need to drive a target pixel circuit, the set potential, which is an output from input circuit 202, of driving wiring V at a corresponding time point may be set to be equal to, for example, V0 which is the initial voltage, so that the corresponding pixel can be turned off. Moreover, a pixel which is instructed to start emitting light by the line driving may be turned off with an instruction of turning off by a similar process in the next line.

As described above, line scanning circuit 201 is used to scan pixels sequentially, so that pixel circuits 71 to 73 which are arranged in line can be turn on or off as needed. Moreover, each pixel can be driven to be any of driving states. Thus, even if light-emitting efficiency varies slightly due to variations or the like among light-emitting elements caused during the light-emitting element manufacturing processes, the effects of the variations can be solved by changing a command voltage of the driving state so as to correct the variations.

An organic EL diode which is used in a print head having a conventional configuration has the following problems. Specifically, one of the problems is that increasing driving current is difficult so that desired light-emitting power can not be obtained because a lifespan of the organic EL diode becomes shorter due to electrical deterioration. The other problem is that current driving capability of a transistor is small and light-emitting luminous energy of a driven element which is driven by the transistor falls short because the transistor used for the driving the element is manufactured by the publicly known TFT technique using a material such as low-temperature polysilicon or amorphous silicon in which carrier mobility cannot be increased.

In the second embodiment with the above configuration, light-emitting transistor Q2 made of a crystal material such as an AlGaAs substrate is used as a light-emitting element in place of an organic EL diode. Thus, there is no problem of aged deterioration so that the driving current can be increased, thereby obtaining larger light-emitting output. In addition, the current amplification factor of light-emitting transistor Q2 is large, and a small base current has a large current driving capability. As a result, even if a TFT element whose current driving capability is inferior as a driving circuit for controlling light-emitting transistor Q2 is used, the TFT element can sufficiently perform the control. Accordingly, the second embodiment can solve a technical problem included in the conventional configuration.

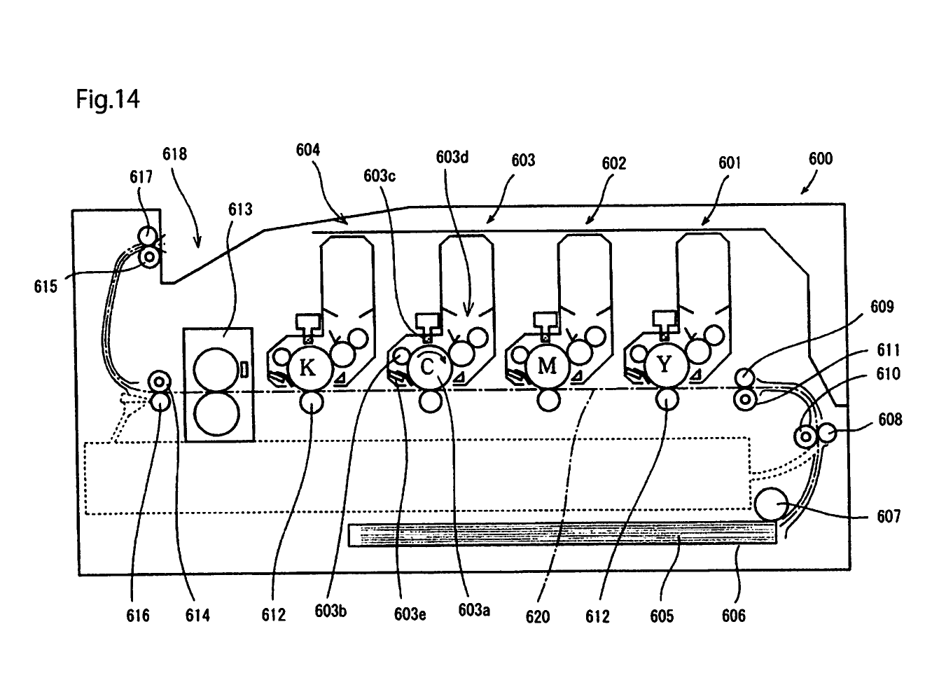

The driving circuits described in the first and second embodiments can be utilized as a light source in the exposure process in an electrophotographic printer. In the following, description is given of a tandem color printer as one example of such an electrophotographic printer by referring to FIG. 14. FIG. 14 is a schematic configurational view showing a tandem color printer using a print head on which the semiconductor compound device according to the invention is mounted.

In FIG. 14, image forming apparatus 600 has four process units 601 to 604 that respectively form images in yellow (Y), magenta (M), cyan (C), and black (K), and are arranged in this order from the upstream of a conveyance path of recording medium 605 to the downstream. Since the interior configurations of process units 610 to 604 are the same, the interior configuration of process unit 603 of color cyan is described as an example.

Process unit 603 has photosensitive drum 603a provided, as an image carrier, so as to be rotatable in the direction of the arrow. Provided around photosensitive drum 603a in the order from upstream of the rotating direction are: charging device 603b which supplies electric charges to the surface of photosensitive drum 603a to charge the surface; and exposure device 603c which forms an electrostatic latent image by selectively emitting light to the surface of charged photosensitive drum 603a. As exposure device 603c, a print head (19) described in each of the above-described embodiments is employed. Moreover, there are provided: developing device 603d which generates a visual image by causing cyan toner (a predetermined color) to attach to the surface of photosensitive drum 603a on which the electrostatic latent image is formed; and cleaning device 603e which removes toner remaining after transfer of the toner of the visualized image onto photosensitive drum 603a. The drums and rollers which are used in the devices are rotated by power which is transmitted from an unillustrated driving source via gears or the like.

In addition, image forming apparatus 600 has paper cassette 606 which is mounted in a lower portion thereof and which accommodates recording media 605 such as paper with being stacked. Above Paper cassette 606, hopping roller 607 is provided for conveying recording media 605 separately sheet by sheet. Furthermore, downstream of hopping roller 607 in the conveyance direction of recording medium 605, there are provided: conveyance roller 610 which holds and conveys the recording medium 605 in cooperation with pinch roller 608; and registration roller 611 which holds recording medium 605, corrects skew of recording medium 605, and conveys the recording medium 605 to process unit 601 in cooperation with pinch roller 609. Power is transmitted from the unillustrated driving source via gears or the like to rotate hopping roller 607, conveyance roller 610, and registration roller 611.

Each of process units 601 to 604 has transfer roller 612 provided in a position facing corresponding photosensitive drum 603a. Transfer roller 612 is formed of, for example, a semiconductor rubber and transfers the visible toner image attached to photosensitive drum 603a onto recording medium 605. A potential for generating a potential difference between the surface potential of each of photosensitive drums 601a to 604a and the surface potential of each transfer roller 612 is applied to each transfer roller 612 when the visible toner image on photosensitive drum 603a is transferred onto recording medium 605.

Fixing device 613 has a heating roller and a backup roller and fixes the toner which is transferred onto recording medium 605 by applying pressure and heat. Discharging rollers 614 and 615 are disposed downstream of fixing device 613. Discharging rollers 614 and 615 hold recording medium 605 discharged from fixing device 613 by respectively cooperating with pinch rollers 616 and 617 of a discharging unit and convey the recording medium 605 to recording medium stacker unit 618. Fixing device 613, discharging roller 614 and the like are rotated by power which is transmitted from the unillustrated driving source via a gear or the like.

Next, the operation of image forming apparatus 600 having the above configuration is described. First, recording media 605, which are accommodated in a stacked state in paper cassette 606, are conveyed separately sheet by sheet from the top by hopping roller 607. Subsequently, recording medium 605 is held between conveyance roller 610 and pinch roller 601 and between registration roller 611 and pinch roller 609 and conveyed to a portion between photosensitive drum 601a and transfer roller 612 of process unit 601 of yellow color. After that, recording medium 605 is held between photosensitive drum 601a and transfer roller 612 during which a toner image is transferred onto the recording surface of the recording medium 605 and, at the same time, is further conveyed downstream along with the rotation of photosensitive drum 601a.

Similarly, recording medium 605 sequentially passes through process units 602 to 604. During passage through the process units 602 to 604, toner images in corresponding colors in which electrostatic latent images formed by exposure devices 601c to 604c are developed by developing devices 601d to 604d are sequentially transferred and superimposed onto the recording surface of the recording medium 605. After the toner images in corresponding colors are superimposed on the recording surface, the toner images are fixed by fixing device 613. Recording medium 605 after fixing is held between discharging roller 614 and pinch roller 616 and between discharging roller 615 and pinch roller 617 and discharged to recording medium stacker unit 618 outside of image forming apparatus 600. After all these processes, a color image is formed on recording medium 605.

Employing a print head having a light-emitting transistor (Q1 or Q2) as a light-emitting element as described above, the image forming apparatus of the invention is capable of providing a high quality image forming apparatus (such as a printer or copier) with space efficiency and exposure efficiency. In other words, using print heads 19 of the first and second embodiments is advantageous not only for the above-described full-colored image forming apparatus but also for monochrome and multi-colored image forming apparatus. In particular, a greater effect can be obtained in the full-colored image forming apparatus which requires a number of exposure devices

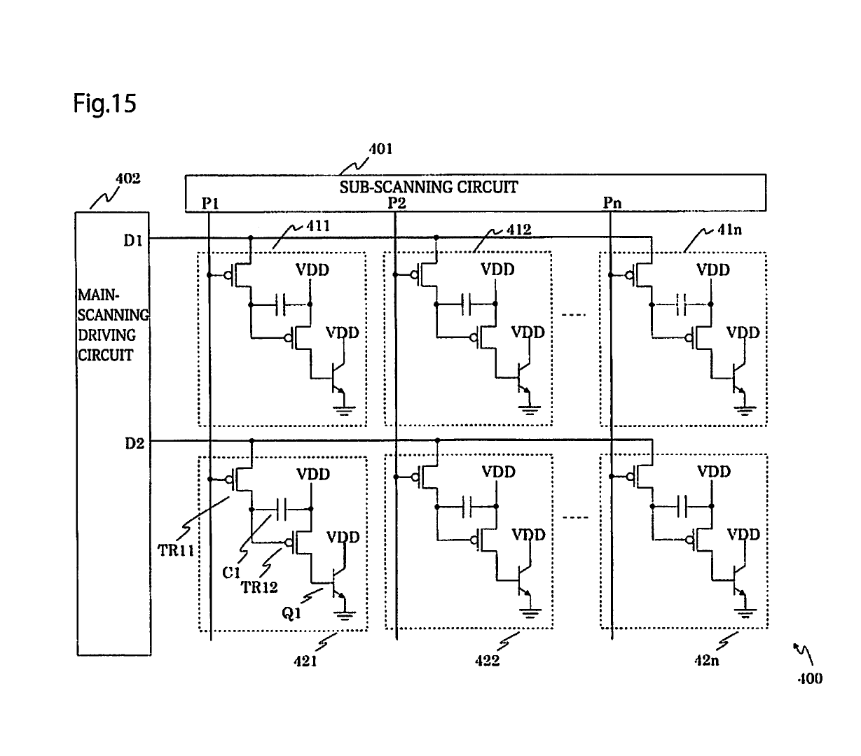

Although the description is given of the case where a driving circuit of the invention is applied to a print head, the invention can be applied not only to a print head in which light-emitting elements are arranged one-dimensionally but also a display panel in which light-emitting elements are arranged two-dimensionally on a plane. Next, an example in which light-emitting elements are applied to a display panel is described by referring to FIG. 15.

FIG. 15 shows display panel 400 which includes main scanning driving circuit 402, sub-scanning circuit 401, and pixel circuits 411, 412, 41n, 421, 422, and 42n which are surrounded by short dashed lines. Each of the pixel circuits is formed of the same circuit. For example, pixel circuit 421 is configured of PMOS transistors TR11 and TR12, capacitor C1, and light-emitting transistor Q1. The gate of PMOS transistor TR11 is connected to output terminal P1 of sub-scanning circuit 401, the source terminal of PMOS transistor TR11 is connected to output D2 of main scanning driving circuit 402, and the drain of PMOS transistor TR11 is connected to the gate of PMOS transistor TR12 and one side of capacitor C1. The other side of capacitor C1 is connected to the source of PMOS transistor TR12 and power supply VDD. The drain of PMOS transistor TR12 is connected to the base of light-emitting transistor Q1. The collector of light-emitting transistor Q1 is connected to power supply VDD and the emitter of light-emitting transistor Q1 is connected to ground. Other pixel circuits have a similar configuration. Main scanning driving circuit 402, sub-scanning circuit 401, and pixel circuits 411, 412, 41n, 421, 422, and 42n constitute a display panel light-emitting unit to be described later.

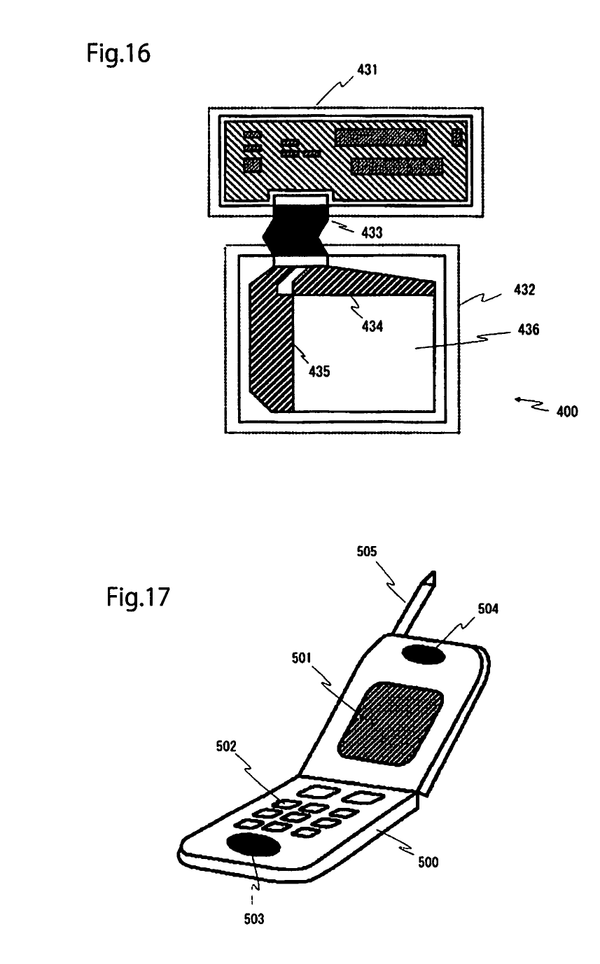

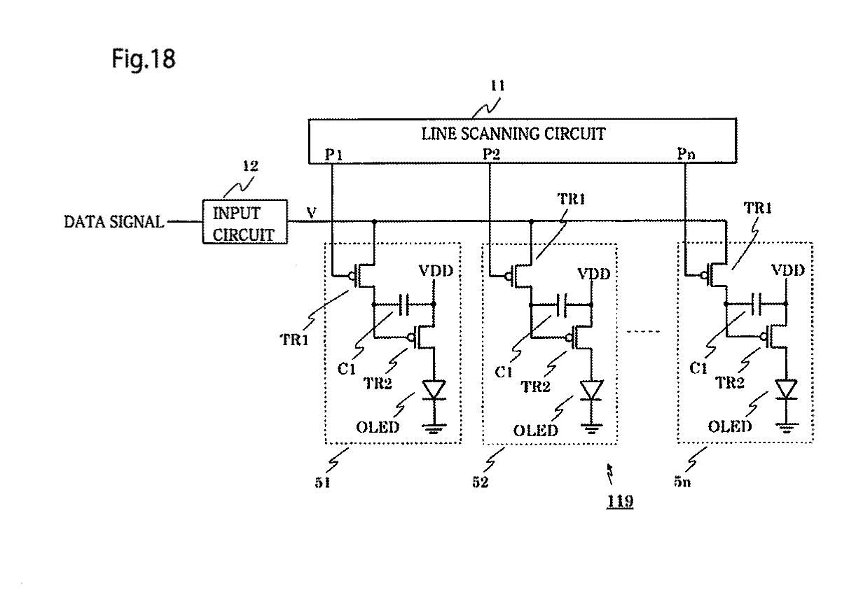

FIG. 16 is a view showing how a display panel with the configuration shown in FIG. 15 is mounted. FIG. 16 shows display panel 400 which includes display panel light-emitting unit 432 described in FIG. 15, control circuit board 431, and flexible flat cable 433 connecting control circuit board 431 with display panel light-emitting unit 432. In addition, display panel light-emitting unit 432 includes main scanning wire 434 which connects above-described main scanning driving circuit 402 with pixel circuits 436, sub-scanning wiring 435 which connects sub-scanning circuit 401 with pixel circuits 436, and pixel circuit 436.

FIG. 17 shows the configuration of a mobile phone as an example of a device employing the display panel described in FIG. 16. FIG. 17 shows mobile phone body 500 which includes display panel light-emitting unit 501, operational switch 502, voice input unit 503 using a microphone or the like, voice output unit 504 including a speaker or the like, and transmitting-receiving antenna 505.

The invention contains other embodiments which do not depart from the scope of the embodiments described herein. The embodiments described herein are intended to describe the invention, and not to limit the scope thereof. The scope of the invention is defined by the description of claims not by the specification described herein. Accordingly, the invention contains all the embodiments including meaning and scope within the scope of the following claims and their equivalents.

What is claimed is:

1. A driving circuit, comprising:
pixel driving circuits, each including:
a driven element formed of a three-terminal light-emitting element,
a control element formed of a three-terminal element and configured to control the driven element,
a driving element formed of a three-terminal element and configured to drive the driven element, and
a charge holding element configured to hold a charge of the driven element;
a first designating circuit configured to output a first designating signal to the control element, the first designating signal designating one of the pixel driving circuits; and
a second designating circuit configured to output a second designating signal to the control element, the second designating signal designating a driving state of the driven element.

2. The driving circuit according to claim 1, wherein the driven element is an NPN-type light-emitting transistor.

3. The driving circuit according to claim 1, wherein
the control element includes a first terminal connected to the second designating circuit, a second terminal connected to a third terminal of the driving element, and a third terminal connected to the first designating circuit,
the driving element includes a first terminal connected to a power supply, and a second terminal connected to a third terminal of the driven element,
the charge holding element includes two sides respectively connected to the first terminal and the third terminal of the driving element, and
the driven element has a first terminal connected to ground and a second terminal connected to a power supply.

4. The driving circuit according to claim 1, wherein
the control element has a first terminal connected to a third terminal of the driving element, a second terminal connected to the second designating circuit, and a third terminal connected to the first designating circuit,
the driving element includes a first terminal connected to a ground, and a second terminal connected to a third terminal of the driven element,
the charge holding element includes two sides respectively connected to the first terminal and the third terminal of the driving element, and
the driven element includes a first terminal connected to a power supply and a second terminal connected to ground.

5. A recording head comprising the driving circuit according to claim 1.

6. The recording head according to claim 5, further comprising
an optical element through which light emitted from the driven element travels.

7. The recording head according to claim 5, further comprising:
a circuit board having the driving circuit.

8. The recording head according to claim 5, further comprising:
a circuit board including the driving circuit; and
an optical element through which light emitted from the driven element of the driving circuit travels.

9. An image forming apparatus comprising the recording head according to claim 5.

10. The image forming apparatus according to claim 9, further comprising:
an image carrier;
a charging device configured to charge the surface of the image carrier;
an exposure device including the recording head and configured to emit light to the surface of charged image carrier so as to form an electrostatic latent image on the surface of charged image carrier;
a developing device configured to develop the electrostatic latent image on the image carrier by supplying a developer to the surface of the image carrier so as to form a developer image;
a transfer unit configured to electrostatically transfer the developer image from the surface of the image carrier onto medium;
a fixing unit configured to fix the developer image to the media by heating the developer image on the media.

11. A display device comprising the driving circuit according to claim 1.

12. The display device according to claim 11, wherein the light-emitting elements of the pixel driving circuits are arranged two-dimensionally on a plane.
